(19) United States
(12) Patent Application Publication
(10) Pub. No.: US 2005/0106403 A1
(43) Pub. Date: May 19, 2005

(54) Shaped metal article and method of producing shaped metal article having oxide coating

(75) Inventor: Yasushi Yui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/986,131

(22) Filed: Nov. 12, 2004

(30) Foreign Application Priority Data
Nov. 13, 2003 (JP) 2003-383441

(51) Int. Cl. B32B 15/04; B32B 9/00; B05D 1/18

(52) U.S. Cl. 428/469; 428/689; 428/702; 427/430.1

(57) ABSTRACT

A shaped metal article comprising a metal body having applied on a surface thereof an oxide coating, in which the metal body is constituted from a single metal selected from the group consisting of magnesium, aluminum and zinc, or a metal alloy containing as a principal component at least one metal selected from the group consisting of magnesium, aluminum and zinc, and the oxide coating is an oxide coating formed upon the surface treatment or anodization treatment of the metal body in a treating solution containing an aluminum salt as a principal component thereof, and a method of producing the shaped metal article having an oxide coating are disclosed.

### CROSS-REFERENCE TO RELATED APPLICATIONS

This application is based upon and claims priority from Japanese Patent Application No. 2003-383441, filed on Nov. 13, 2003.

### BACKGROUND OF THE INVENTION

1. Field of the Invention

The present invention relates to a shaped metal article having a protective oxide coating and a method of producing such a shaped metal article, in other words, a method of treating a surface of the shaped metal article. More particularly, the present invention relates to a method of treating a surface of the shaped metal article such as a shaped metal cover, casing or housing, made of, for example, a lightweight alloy of metal such as magnesium and aluminum, used in a variety of information processing devices such as notebook-size personal computers, pen-input personal computers, personal digital assists (PDA) and cellular phones, to thereby form a chromium (Cr)-free protective oxide coating having a controlled conductivity or appearance color useful in the field of protection of the cover or casing from rust or the field of electromagnetic wave shielding, for example.

2. Description of the Related Art

Hitherto, metal materials having a relatively low specific gravity such as magnesium (1.8 g/cm³) and aluminum (2.7 g/cm³) have been widely used in the production of electronic devices such as personal computers and cellular phones, because such low specific gravity metals can ensure high strength, light weight, reduction in the thickness, environment protection and recycling in the devices (see, for example, Japanese Unexamined Patent Publication (Kokai) No. 2001-286969).

In the production of the electronic devices and others, when a lightweight metal alloy based on, for example, magnesium is used as a casing or housing material, it was necessary to apply a paint coating to a surface of the housing to obtain an improved rust proofing and appearance, and thus it was conventional in the prior art devices to use the JIS method (see, the instructions described in Japanese Industrial Standard: JIS H8651) or DOW method which includes formation of an oxide coating using a chromium compound such as hexavalent chromium which would adversely affect the environment.

For example, in the conversion treatment of the shaped articles made of a magnesium alloy, after completion of the pretreatment such as defatting, etching and acid washing, the shaped articles are subjected to the conversion treatment by dipping the articles in a chromate solution to form an oxide coating of hexavalent chromium on a surface of the articles, followed by the aftertreatment such as water washing and drying. According to this method, a resistance value of the resulting oxide coating of hexavalent chromium can be controlled to a level of not more than 100Ω.

However, use of the chromium compound in the surface treatment of the shaped metal articles suffers from the problem that the resulting coating contains hexavalent chromium which is a target of environmental regulations, in addition to the problem that only a poor appearance is obtained because the resulting coating shows undesirable colors such as brown or yellow. To avoid these problems, attention has been made to an alternative method based on the formation of a non-chromium (Cr), i.e., Cr-free oxide coating (see, for example, Japanese Unexamined Patent Publication (Kokai) No. 11-29874).

However, in the Cr-free oxide coating disclosed in JPP'874, there is a problem that the conductivity cannot be sufficiently controlled and also the appearance color cannot be freely controlled in the resulting coating.

### SUMMARY OF THE INVENTION

It is an object of the present invention to provide a clean process which does not use toxic substances such as hexavalent chromium, mercury (Hg), cadmium (Cd) and zinc (Zn) in the formation of an oxide coating on a surface of the shaped metal articles, while improving conductivity and appearance color in the resulting oxide coating.

It is another object of the present invention to provide a shaped metal article having an oxide coating free from toxic substances such as hexavalent chromium, Hg, Cd and Zn and capable of easily controlling the conductivity and appearance color.

It is still another object of the present invention to provide a method of producing such a shaped metal article having an excellent oxide coating.

These and other objects of the present invention will be easily understood from the following detailed descriptions concerning the preferred embodiments and examples of the present invention.

According to one aspect of the present invention, there is provided a shaped metal article comprising a metal body having applied on a surface thereof an oxide coating, in which

the metal body is constituted from a single metal selected from the group consisting of magnesium, aluminum and zinc, or a metal alloy containing as a principal component at least one metal selected from the group consisting of magnesium, aluminum and zinc, and

the oxide coating is an oxide coating formed upon a surface treatment of the metal body in a treating solution containing an aluminum salt as a principal component thereof.

In the shaped metal article according to the present invention, preferably, the oxide coating is a chromium-free oxide coating and, also, the oxide coating has a controlled conductivity and/or appearance color. Preferably, the controlled conductivity and/or appearance color of the oxide coating can be obtained by controlling at least one factor selected from a composition of the treating solution containing an aluminum salt and a dipping time of the metal body in the treating solution.

According to another aspect of the present invention, there is provided a shaped metal article comprising a metal body having applied on a surface thereof an oxide coating, in which

the metal body is constituted from a single metal selected from the group consisting of magnesium, aluminum and zinc, or a metal alloy containing as a principal component at least one metal selected from the group consisting of magnesium, aluminum and zinc, and

the oxide coating is an oxide coating formed upon an anodization treatment of the metal body in a treating solution containing an aluminum salt as a principal component thereof.

In the shaped metal article according to the present invention, preferably, the oxide coating is a chromium-free oxide coating, and also the oxide coating has a controlled conductivity and/or appearance color. Preferably, the controlled conductivity and/or appearance color of the oxide coating can be obtained by controlling at least one factor selected from a composition of the treating solution containing an aluminum salt, an applied voltage and an application time of the voltage.

Further, it is preferred, in the shaped metal article of the present invention, that the oxide coating further comprises at least one synthetic resin layer applied thereon.

Furthermore, it is preferred in the shaped metal article that the synthetic resin coating formed on the oxide coating further comprises at least one metal layer applied thereon.

In addition, it is also preferred that the shaped metal article further comprises a sheet-like member having coated thereon at least one metal layer. The sheet-like member is preferably at least partly contacted the oxide coating. Further, the sheet-like member is selected from the group consisting of a resin film, a metal tape, a metal sheet, an insulating tape of synthetic resin and an insulating sheet of synthetic resin. In this shaped metal article, it is preferred that the resin film is a metal layer single coated substrate, a metal layer duplitized substrate, a metal layer-sandwiched substrate or a flexible substrate.

In addition, it is preferred in the shaped metal article that the aluminum salt contained in the treating solution is at least one member selected from the group consisting of aluminum chloride, aluminum fluoride, aluminum sulfate, aluminum nitrate, aluminum carbonate and aluminum hydroxide.

Moreover, it is preferred that the shaped metal article of the present invention is a constitutional member or part of an electronic device or electric equipment. Preferably, the shaped metal article is used as a cover of the information processing device or a casing of the electronic device or electric equipment, for example. The shaped metal cover, casing or housing, made of, for example, a lightweight alloy of the metal such as magnesium and aluminum, can be advantageously used in a variety of information treating devices such as notebook-size personal computers, pen-input personal computers, personal digital assists (PDA) and cellular phones.

According to still another aspect of the present invention, there is provided a method of producing a shaped metal article comprising a metal body having applied on a surface thereof an oxide coating, which comprises:

providing a metal body having a shaped profile from a single metal selected from the group consisting of magnesium, aluminum and zinc, or a metal alloy containing as a principal component at least one metal selected from the group consisting of magnesium, aluminum and zinc, and

subjecting the metal body to a surface treatment by immersing the metal body in a treating solution containing an aluminum salt as a principal component thereof, to form an oxide coating on a surface of the metal body.

In the method of the present invention, it is preferred that the surface treatment is carried out under the conditions of controlling at least one factor selected from a composition of the treating solution containing an aluminum salt and a dipping time of the metal body in the treating solution containing an aluminum salt to obtain a controlled conductivity and/or appearance color in the resulting protective oxide coating.

Furthermore, according to still another aspect of the present invention, there is provided a method of producing a shaped metal article comprising a metal body having applied on a surface thereof an oxide coating, which comprises:

providing a metal body, having a shaped profile, from a single metal selected from the group consisting of magnesium, aluminum and zinc, or a metal alloy containing as a principal component at least one metal selected from the group consisting of magnesium, aluminum and zinc, and

subjecting the metal body to an anodization treatment by immersing the metal body in a treating solution containing an aluminum salt as a principal component thereof, to form an oxide coating on a surface of the metal body.

In the method of the present invention, it is preferred that the anodization treatment is carried out under the conditions of controlling at least one factor selected from a composition of the treating solution containing an aluminum salt, an applied voltage and an application time of the voltage to obtain a controlled conductivity and/or appearance color in the resulting protective oxide coating.

In the practice of the method according to the present invention, it is preferred that:

the method further comprises forming at least one synthetic resin layer on the oxide coating;

the method further comprises forming at least one metal layer on the synthetic resin coating;

the method further comprises applying a sheet-like member having coated thereon at least one metal layer onto the oxide coating in such a manner that the sheet-like member is at least partly contacted with the oxide coating;

the sheet-like member is selected from the group consisting of a resin film, a metal tape, a metal sheet, an insulating tape of synthetic resin and an insulating sheet of synthetic resin;

the resin film constituting the sheet-like member is a metal layer single coated substrate, a metal layer duplitized coated substrate, a metal layer-sandwiched substrate or a flexible substrate; and/or

the metal tape or metal sheet constituting the sheet-like member is adhered through an adhesive to the oxide coating.

### BRIEF DESCRIPTION OF THE DRAWINGS

FIG. 1 is a cross-sectional view schematically showing a treatment bath used in the surface treatment of the shaped metal article according to the present invention;

FIG. 2 is a cross-sectional view of the oxide coating-deposited shaped metal article produced upon the surface treatment;

FIG. 3 is a cross-sectional view of the oxide coating-deposited shaped metal article of FIG. 2 having applied thereon a synthetic resin layer;

FIG. 4 is a flow-chart showing a production process of the shaped metal article according to Example 1;

FIG. 5 is a cross-sectional view schematically showing a conversion treatment bath used in the surface treatment of the shaped metal article according to Example 1;

FIG. 6 is a cross-sectional view of the oxide coating-deposited shaped metal article produced upon the surface treatment according to Example 1;

FIG. 7 is a flow-chart showing a production process of the shaped metal article according to Example 2;

FIG. 8 is a cross-sectional view schematically showing an anodization treatment bath used in the surface treatment of the shaped metal article according to Example 2;

FIG. 9 is a cross-sectional view of the oxide coating-deposited shaped metal article produced upon the surface treatment according to Example 2;

FIG. 10 is a flow-chart showing a production process of the shaped metal article according to Example 3;

FIG. 11 is a cross-sectional view of the oxide coating-deposited shaped metal article having applied thereon an epoxy resin layer produced upon the surface treatment according to Example 3;

FIG. 12 is a flow-chart showing a production process of the shaped metal article according to Example 4;

FIG. 13 is a cross-sectional view of the oxide coating-deposited shaped metal article having applied thereon, in sequence, an epoxy resin layer and an electromagnetic wave shield layer produced upon the surface treatment according to Example 4;

FIG. 14 is a flow-chart showing a process of mounting a printed circuit board on the shaped metal article according to Example 5;

FIG. 15 is a cross-sectional view of the oxide coating-deposited shaped metal article having mounted thereon a printed circuit board produced upon the process according to Example 5;

FIG. 16 is a flow-chart showing a process of mounting a printed circuit board on the shaped metal article according to Example 6;

FIG. 17 is a cross-sectional view of the oxide coating-deposited shaped metal article having mounted thereon a printed circuit board produced upon the process according to Example 6;

FIG. 18 is a flow-chart showing a process of mounting a printed circuit board on the shaped metal article according to Example 7; and

FIG. 19 is a cross-sectional view of the oxide coating-deposited shaped metal article having mounted thereon a printed circuit board produced upon the process according to Example 7.

### DESCRIPTION OF THE PREFERRED EMBODIMENTS

The present invention will be further described with regard to the preferred embodiments thereof. Note, however, that the present invention should not be restricted to these embodiments.

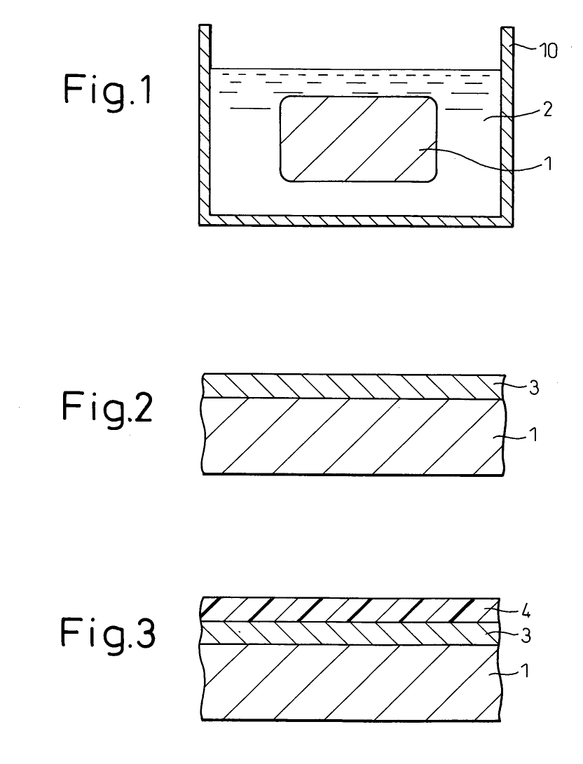

First, the present invention will be described with regard to its basic concept, referring to FIGS. 1 to 3.

The present invention resides in a method of producing a shaped metal article 1 having applied on a surface thereof an oxide coating 3, in other words, a method of surface treating a shaped metal article 1 to form an oxide coating 3 on a surface of the article 1 (see, FIG. 2). The shaped metal article 1 which is also referred herein to as “metal body” may be constituted from a single metal such as magnesium (Mg), aluminum (Al) and zinc (Zn), or alternatively, it may be constituted from a metal alloy containing as a principal component at least one metal selected from the group consisting of magnesium, aluminum and zinc.

The oxide coating-deposited shaped metal article of the present invention is produced upon surface treatment of the metal body having the predetermined shaped profile. That is, the present invention is characterized by immersing a metal body 1 having the shaped profile in a treating solution 2 containing an aluminum salt as a principal component thereof, as is illustrated in FIG. 1, to thereby form an oxide coating. The treating solution 2 is contained in a treatment bath 10. As a result of the surface treatment, as is illustrated in FIG. 2, an oxide coating 3 is deposited on a surface of the metal body, i.e., shaped metal article 1.

In the surface treatment of the metal body, the aluminum salt used in the treating solution includes, for example, aluminum chloride, aluminum fluoride, aluminum sulfate, aluminum nitrate, aluminum carbonate and aluminum hydroxide. According to the present invention, since these aluminum salts can be used in the treating solution 2, it becomes possible to form an oxide coating 3 having an excellent rust resistance on a surface of the shaped metal article 1 made of, for example, light metals such as Mg, Al and Zn without using toxic substances such as hexavalent chromium, while ensuring a controlled appearance color such as tin white, gray and white.

Further, according to the present invention, as heavy metals such as Cr and Mn are not used as one member in the formation of the oxide coating, the efficiency in the recovery of the used articles and the recycling process can be improved.

In the practice of the present invention, the composition of the treating solution 2 containing the aluminum salt as the principal component or the dipping time of the metal body 1 in the solution 2 can be modified to control an electrical conductivity or appearance color of the resulting oxide coating 3. It has been found that a resistance value of the oxide coating 3 can be increased or an appearance color of the coating 3 can be varied from tin white through gray to while, with increase of the content or concentration of the aluminum salt in the treating solution or extension of the dipping time of the metal body in the treating solution.

Alternatively, an oxide coating 3 can be deposited on a surface of the metal body 1 by subjecting a metal body 3, made of a single metal of Mg, Al or Zn or a metal alloy containing as a principal component thereof at least one of these single metals, to an anodization treatment in a treating solution 2 containing an aluminum salt as a principal component thereof.

As in the surface treatment method described above, the conductivity or appearance color of the resulting oxide coating 3 can be controlled by changing a composition of the treating solution 2 containing an aluminum salt and an applied voltage or application time of the voltage in the anodization process. Further, as the voltage is applied to the metal body 1 during the anodization process, it becomes possible to shorten the treating or dipping time of the metal body 1 in the treating solution 2.

In the formation of the oxide coating 3, a resistance value of the oxide coating 3 can be increased, or an appearance color of the oxide coating 3 can be varied from tin white through gray to white, with increase of a concentration of the solution 2, with increase of an applied voltage, or with extension of the dipping time of the metal body 1 in the solution 2.

In addition, according to the present invention, after formation of an oxide coating 3 in accordance with the above-described surface treatment methods, at least one synthetic resin layer 4 may be formed on the oxide coating 3, as is illustrated in FIG. 3. The resin layer 4 is effective to improve a rust resistance and corrosion resistance of the underlying oxide coating 3.

Moreover, after formation of the synthetic resin layer, a metal layer may be further deposited on the synthetic resin layer to obtain an electromagnetic wave-shielding effect in the resulting shaped metal article. In particular, it should be noted that if an oxide coating applied to the metal body is electrically conducting, the resulting electromagnetic wave-shielding effect can be further improved as a function of the sandwiching of the oxide coating and the metal layer.

Alternatively, after formation of an oxide coating, there may be applied over the oxide coating a sheet-like member having coated thereon at least one metal layer, in which the sheet-like member is any one of a resin film, a metal tape, a metal sheet, an insulating tape of synthetic resin and an insulating sheet of synthetic resin. The sheet-like member is at least partly contacting the oxide coating. Further, the resin film may be a metal layer single coated substrate, a metal layer duplitized substrate, a metal layer-sandwiched substrate or a flexible substrate. Application of the metal layer-bearing resin film, metal tape or metal sheet to the shaped metal article is effective to improve an electromagnetic wave-shielding effect.

Furthermore, if the insulating tape of synthetic resin or the insulating sheet of synthetic resin is applied to the shaped metal article, it is effective to improve a stability of the resulting products, because the erroneous contact and short-circuit can be prevented when an electronic device or a printed circuit board, for example, is mounted on the shaped metal article of the present invention.

The present invention will be further described with regard to the constitution of the shaped metal article, the surface treatment of the metal body, and other features.

According to the present invention, a shaped metal article is first produced from a metal material such as a single metal, for example, magnesium, aluminum and zinc, or a metal alloy containing such metal as a principal component. The metal material is subjected to a shaping procedure such as die casting, thixotropic molding, sheet pressing and forging to obtain a shaped metal article having the desired profile. The shaped metal article is then subjected to the pretreatment such as defatting, etching, neutralization, acid washing, blasting, hair line finishing and buffing. After the pretreatment, the metal article is dipped in a treating solution which is prepared by mixing a suitably controlled amount of the additives to a solution containing about 0.1 to 1,000 g/l of an aluminum salt such as aluminum chloride, aluminum fluoride, aluminum sulfate, aluminum nitrate, aluminum carbonate and aluminum hydroxide. The additives added to the treating solution include, for example, a combination of:

0 to 500 g/l of zirconium salt such as zirconium sulfate and zirconium chloride;

0 to 100 g/l of sodium dodecyl sulfate as a surface active agent;

0 to 500 g/l of benzotriazole as a rust inhibitor; and

0 to 1,000 g/l of phosphoric acid and 0 to 1,000 g/l of hydrofluoric acid as a pH controlling and oxidizing agent.

If desired, the resulting treating solution is further subjected to stirring, aeration and shaking to maintain the solution in a uniform condition. Using the treating solution, the metal article is subjected to a non-chromium (Cr) treatment such as a conversion treatment and an anodization treatment, while the treating temperature is maintained at an optionally determined temperature within the range of −20 to 100° C. An oxidized coating which is also referred herein to as “oxide coating” is thus formed on a surface of the metal article. After formation of the oxidized coating, the metal article is subjected to the aftertreatment such as water washing, hot water washing, pure water washing and drying (for example, 0 to 120 minutes at 50 to 100° C.).

In the non-chromium treatment described above, the treatment time is preferably within the range of 0 to 60 minutes, and is the time sufficient to deposit the oxidized coating at a thickness of not more than 50 μm, for example, at a thickness of about 1 to 5 μm. There is a tendency that the resistance value of the oxidized coating approaches to an insulation level, with an increase of the treatment time.

Further, when the non-chromium treatment is an anodization treatment, the applied voltage is adjusted to generally about 0 to 1,000 volts, preferably about 50 to 100 volts, and the electric current of about 0 to 100 A, preferably about 0.01 to 1 A is applied to the treatment process.

Furthermore, if desired, to improve a rust resistance and corrosion resistance in a surface of the resulting oxidized coating, one or more layers may be formed from a synthetic resin material such as an acrylic resin, acryl-urethane resin, acryl-silicone resin, acryl-epoxy resin, epoxy resin, melamine resin, acryl-melamine resin, melamine-epoxy resin, polyester resin, polyester-epoxy resin and fluorinated ethylene-based compound. The formation of the synthetic resin layer on the oxidized coating can be carried out by using any conventional layer formation method such as coating, spraying, electrostatic spraying, dipping, electroplating, powder deposition and layer formation using an aqueous emulsion.

Moreover, to improve an electromagnetic wave-shielding effect, the synthetic resin layer may be further covered with a metal layer such as aluminum, nickel, chromium, brass, copper, silver, gold, titanium, iron, zinc, platinum, rhodium, cobalt, tin, carbon, boron, bismuth, indium or an alloy thereof. The metal layer can be formed on the synthetic resin layer by using any conventional method such as plating, vacuum deposition, sputtering and ion plating.

Alternatively, to improve an electromagnetic wave-shielding effect, the synthetic resin layer may be further laminated or adhered with a resin film or sheet having coated thereon at least one metal layer such as a metal layer single coated substrate, a metal layer duplitized substrate, a metal layer-sandwiched substrate and a flexible substrate.

In addition, to improve an electromagnetic wave-shielding effect along with improvement of the grounding property, a tape or sheet made of an electrically conductive material such as copper, silver, gold, aluminum, carbon, iron, stainless steel, titanium, tin, nickel and chromium may be adhered to the oxidized coating through, for example, an acrylic, epoxy-based or polyester-based adhesive.

In an alternate method, to protect the printed circuit boards or the electronic parts or elements mounted on the circuit board from undesirable electric contact or short-circuiting to thereby improve a stability of the devices, an insulating sheet or tape made of, for example, polyester, nylon or polyimide may be applied to the oxidized coating in such a manner that the insulating sheet or tape contacts the oxidized coating.

As can be appreciated from the above descriptions of the present invention and the appended examples, according to the present invention, a high quality oxide coating having an excellent rust resistance can be formed on a surface of the shaped metal article, which is made of, for example, a light metal alloy such as magnesium, aluminum and zinc alloys and is used in the information processing devices such as personal computers and cellular phones, by subjecting the shaped metal article to a conversion treatment or an anodization treatment in a treating solution containing an aluminum salt as a principal component, without using any toxic substance such as hexavalent chromium.

Further, in the conversion treatment or the anodization treatment, the treatment conditions applied in the practice of the present invention such as concentration of the treating solution, the treating time and temperature and the applied voltage can be freely controlled to thereby adjust a resistance value of the resulting oxide coating to any desired value such as a good conductivity level of not more than 10Ω, an electrostatic prevention level of not more than 10KΩ or a higher insulating level. That is, the treatment conditions of the shaped metal article can be freely determined depending upon the intended applications of the shaped metal article.

Furthermore, according to the present invention, when an insulating layer made of a synthetic resin and others, a metal layer or a resin sheet containing an electrically conducting layer or coating, for example, is deposited over or adhered to the oxide coating to thereby contact the insulating layer or others the underlying oxide coating, it becomes possible to improve an electromagnetic wave-shielding effect or durability of the casing or housing, for example, using the shaped metal article of the present invention.

Especially, when the sandwich structure consisting of a conductive layer—an insulating layer—a conductive layer is applied to the shaped metal article, it becomes possible to prevent or diminish a generation of noise in the semiconductor devices, electronic parts or elements, substrates, electronic sources and other devices as a function of the created capacitor effect.

Moreover, based of these remarkable effects and functions, the present invention can be advantageously applied to the surface treatment of a casing, housing or the like in a variety of electronic or electric devices or apparatuses including large-sized information processing devices, in addition to the application to the conventional surface treatment of, for example, the cover of the small-sized information processing devices such as notebook-size personal computers, pen-input personal computers, personal digital assists (PDA) and cellular phones.

### EXAMPLES

The present invention will be further described with reference to the examples thereof.

### Example 1

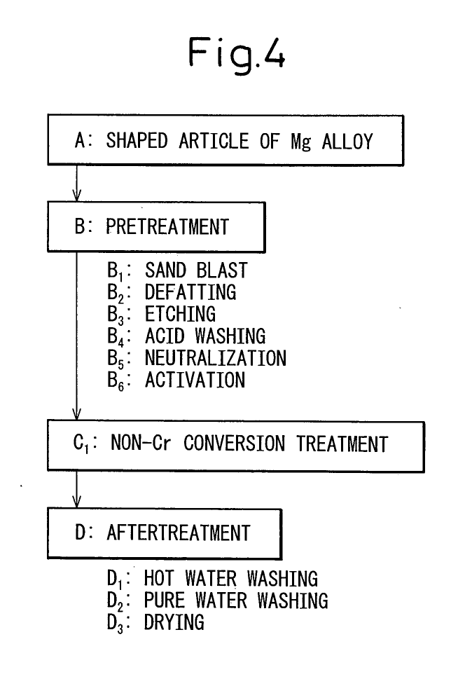

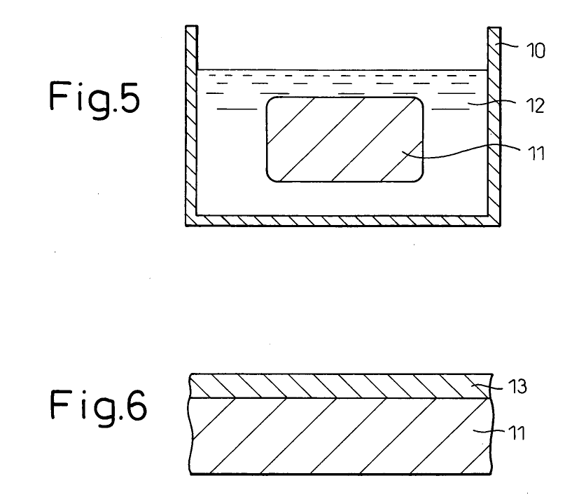

This example is intended to explain the surface treatment of the shaped metal article according to one preferred embodiment of the present invention, referring to FIGS. 4 to 6 in which FIG. 4 is a flow-chart showing a production process of the shaped metal article, FIG. 5 is a cross-sectional view schematically showing a conversion treatment bath used in the surface treatment of the shaped metal article, and FIG. 6 is a cross-sectional view of the oxide coating-deposited shaped metal article produced upon the surface treatment.

First, a magnesium (Mg) alloy prepared by adding Al and Cu to Mg is shaped by die casting to obtain a shaped article 11 of Mg alloy having a predetermined casing structure (see, FIG. 5).

Next, the shaped Mg alloy article 11 is subjected to the pretreatment B₁. In the pretreatment B₁, a surface of the shaped article 11 is roughened with a sand blast method to obtain a surface roughness Rₐ of about 0.1 to 10 μm, along with removal of the contaminations such as oil and a mold-releasing agent. Sand, glass particles and ceramic particles, for example, are used in the sand blast method.

Then, the shaped article 11 is subjected to the pretreatment B₂. In the pretreatment B₂, the shaped article 11 is defatted with an alcohol such as ethanol, methanol and isopropyl alcohol (IPA) or a detergent. Oil, fat and contaminants adhered on the surface of the shaped article 11 can be removed upon this defatting process.

Thereafter, the shaped article 11 is subjected to the pretreatment B₃. In the pretreatment B₃, the shaped article 11 is subjected to etching using an alkaline solution containing, for example, NaOH or KOH to remove projections and others produced during the sand blast processing. A shaped Mg alloy article 11 having a uniformly roughened surface is thus produced.

After etching, the shaped article 11 is subjected to the pretreatment B₄. In the pretreatment B₄, the shaped article 11 is subjected to acid washing using an acidic solution consisting of, for example, HCl, HNO₃, H₂SO₄ or H₃PO₄. Upon this surface treatment, a uniformly roughened surface of the shaped article 11 is further improved.

The pretreatment is further continued. The shaped article 11 is subjected to the pretreatment B₅. In the pretreatment B₅, a surface of the shaped article 11 is neutralized with an alkaline solution which is identical to the solution used in the pretreatment B₃, but at a lower alkali concentration.

Next, a surface of the shaped article 11 is treated with an acidic solution which is identical to the solution used in the pretreatment B₄, but at a lower acid concentration, in the pretreatment B₆ to activate a surface of the shaped article 11, along with neutralization of the remaining alkali originated from the alkali used in the pretreatment B₅.

After completion of the pretreatment steps described above, the shaped Mg alloy article 11 is subjected to the non-chromium (Cr) conversion treatment C₁. For the non-Cr conversion treatment C₁, a non-Cr or Cr-free mixed solution having the following composition is prepared as a treating solution.

100 to 150 g/l of an aluminum salt,

2 to 30 g/l of zirconium sulfate,

0.1 to 0.3 g/l of sodium dodecyl sulfate,

5 to 10 g/l of benzotriazole,

10 to 20 g/l of phosphoric acid, and

10 to 20 g/l of hydrofluoric acid.

Note in this example that, for comparison purposes, three different treating solutions which contain any one of aluminum fluoride, aluminum nitrate and aluminum hydroxide as the aluminum salt are prepared.

Then, the prepared treating solution 12 is contained in a treatment bath 10, followed by immersing the pretreated Mg alloy article 11 in the treating solution 12, as is illustrated in FIG. 5. If desired, the conversion treatment may be carried out in the treating solution 12, with stirring, aeration or shaking of the solution 12. As a result of the conversion treatment, an oxide coating 13 is deposited over a surface of the article 11, as is illustrated in FIG. 6.

In the conversion treatment described above, the conversion treatment is preferably carried out at a temperature of about −20 to 100° C., more preferably about 15 to 35° C., specifically about 20° C. to obtain an oxide coating 13 having a thickness of not more than about 50 μm, for example, a thickness of about 0.1 to 5 μm, depending upon the applications of the resulting article.

After completion of the conversion treatment, the resulting Mg alloy article 11 having the oxide coating 13 is washed with a hot water at about 50 to 60° C. in the after-treatment D₁, washed with a pure water at two or three stages in the after-treatment D₂, and then dried at about 60 to 120° C. for about 0 to 120 minutes in the after-treatment D₃. The shaped Mg alloy article 11 having on a surface thereof the non-Cr oxide coating 13 for improving a rust and corrosion resistance is thus obtained.

The following Table 1 is a table showing a dependency of the resistance value of the resulting oxide coating 13 on a treatment time applied during the conversion treatment. As can be appreciated from Table 1, there is a tendency that the resistance value of the coating 13 is increased with increase of the treatment time for all of the aluminum salts.

It is shown in Table 1 that aluminum fluoride and aluminum nitrate are suitable for the formation of an oxide coating having a good conductivity, because they can maintain a resistance value of not more than 10Ω, while the treatment time is 10 minutes or less.

On the other hand, when aluminum hydroxide is used as the aluminum salt, a resistance value of the oxide coating is increased with increase of the treatment time, and especially, an insulation property is observed in the oxide coating at the treatment time of 5 minutes or more.

The oxide coating, if it has a resistance value of about 10Ω, is suitable as an anti-electrostatic coating.

Moreover, the appearance color of the oxide coating 13 can be changed from a tin white or silver gray color, which is close to the color of the base or bare metal, through a gray color to a white color, with increase of the treatment time. Such a variation of the appearance color in the oxide coating is more preferable in comparison with the conventional chromium oxide coatings, an appearance color of which is only changed from a brown color to a yellow color.

TABLE 1

| | aluminum salt used in treating solution | | |
|---|---|---|---|
| treatment | aluminum | aluminum | aluminum |
| time | fluoride | nitrate | hydroxide |
| 1 minute | not more than | not more than | not more than |
| | 10 Ω | 10 Ω | 10 Ω |
| 5 minutes | not more than | not more than | insulation |
| | 10 Ω | 10 Ω | |
| 10 minutes | not more than | not more than | insulation |
| | 10 Ω | 10 Ω | |

### Example 2

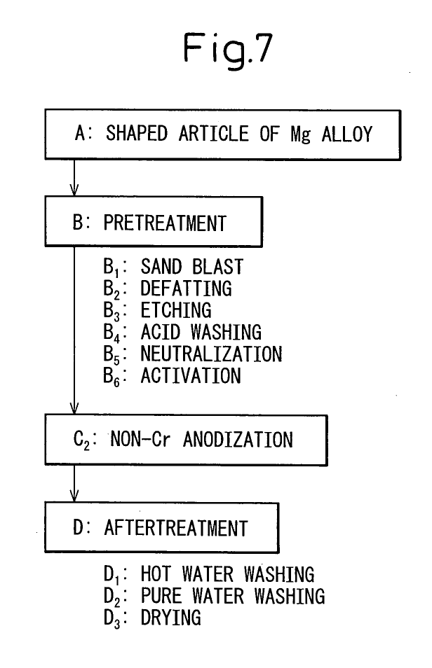

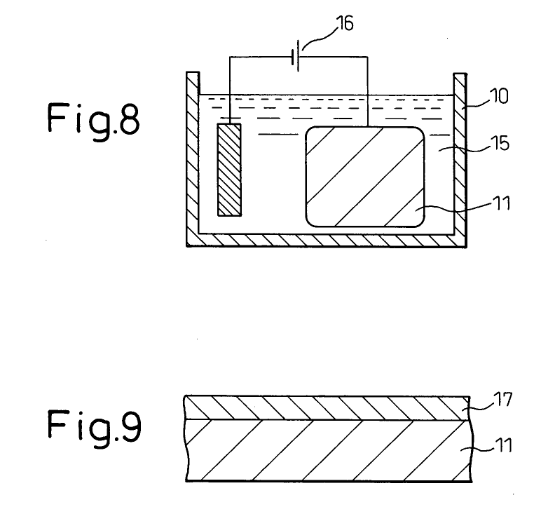

This example is intended to explain the surface treatment of the shaped metal article according to another preferred embodiment of the present invention, referring to FIGS. 7 to 9 in which FIG. 7 is a flow-chart showing a production process of the shaped metal article, FIG. 8 is a cross-sectional view schematically showing an anodization treatment bath used in the surface treatment of the shaped metal article, and FIG. 9 is a cross-sectional view of the oxide coating-deposited shaped metal article produced upon the anodization treatment.

The procedure of Example 1 is repeated to produce the shaped Mg alloy article 11, followed by subjecting the article 11 to the pretreatment steps B₁ to B₆, as is shown in FIGS. 7 and 8. A surface of the shaped Mg alloy article 11 is thus activated and cleaned.

After completion of the pretreatment steps B₁ to B₆, the shaped Mg alloy article 11 is subjected to the non-Cr anodization treatment C₂. For the non-Cr anodization treatment C₂, a non-Cr or Cr-free electrolytic solution having the following composition is prepared as a treating solution.

100 to 150 g/l of an aluminum salt,

2 to 30 g/l of zirconium sulfate,

0.1 to 0.3 g/l of sodium dodecyl sulfate,

5 to 10 g/l of benzotriazole,

10 to 20 g/l of phosphoric acid, and

10 to 20 g/l of hydrofluoric acid.

Note in this example that, for comparison purposes, three different electrolytic solutions which contain any one of aluminum fluoride, aluminum nitrate and aluminum hydroxide as the aluminum salt are prepared.

Then, the prepared electrolytic solution 15 is contained in a treatment bath 10, followed by immersing the pretreated Mg alloy article 11 in the electrolytic solution 15, as is illustrated in FIG. 8. If desired, the anodization treatment may be carried out in the electrolytic solution 15, with stirring, aeration or shaking of the solution 15. As a result of the anodization treatment, an oxide coating 17 is deposited over a surface of the article 11, as is illustrated in FIG. 9.

In this anodization treatment step, as is illustrated in FIG. 8, a voltage of not more than 200 volts, for example, a voltage of about 100 volts, is applied from an electric source 16 to the Mg alloy article 11 at a temperature of about 20 to 30° C. to conduct the anodization treatment. As a result, the oxide coating 17 is deposited at a thickness of not more than about 50 μm, for example, a thickness of about 0.1 to 5 μm, depending upon the applications of the resulting article.

After completion of the anodization treatment, the resulting Mg alloy article 11 having the oxide coating 17 is subjected to the after-treatment steps D₁ to D₃. The shaped Mg alloy article 11 having on a surface thereof the non-Cr oxide coating 17 for improving a rust and corrosion resistance is thus obtained.

The following Table 2 is a table showing a dependency of the resistance value of the resulting oxide coating 17 on a treatment time applied during the anodization treatment. As can be appreciated from Table 2, there is a tendency that the resistance value of the coating 17 is increased with increase of the treatment time for all of the aluminum salts.

It is shown in Table 2 that aluminum fluoride and aluminum nitrate can provide an oxide coating having a resistance value of not more than 1 kΩ with the treatment time of 10 minutes.

On the other hand, when aluminum hydroxide is used as the aluminum salt, a resistance value of the oxide coating is increased with increase of the treatment time as in Example 1, and especially, an insulation property is observed in the oxide coating with the treatment time of 5 minutes or more.

Moreover, the appearance color of the oxide coating 17 can be changed from a tin white or silver gray color, which is close to the color of the base or bare metal, through a gray color to a white color, with increase of the treatment time or increase of the applied voltage. Such a variation of the appearance color in the oxide coating is more preferable in comparison with the conventional chromium oxide coatings, an appearance color of which is only changed from a brown color to a yellow color.

In addition, contrary to the conversion treatment described in Example 1, the anodization treatment of this example can be carried out at an increased reaction velocity because of application of a voltage, thereby allowing a shorter treatment time.

TABLE 2
(Applied voltage: 100 volts)

| | aluminum salt used in treating solution | | |
|---|---|---|---|
| treatment | aluminum | aluminum | aluminum |
| time | fluoride | nitrate | hydroxide |
| 1 minute | not more than | not more than | not more than |
| | 10 Ω | 10 Ω | 1 kΩ |
| 5 minutes | not more than | not more than | insulation |
| | 10 Ω | 10 Ω | |
| 10 minutes | not more than | not more than | insulation |
| | 1 kΩ | 1 kΩ | |

### Example 3

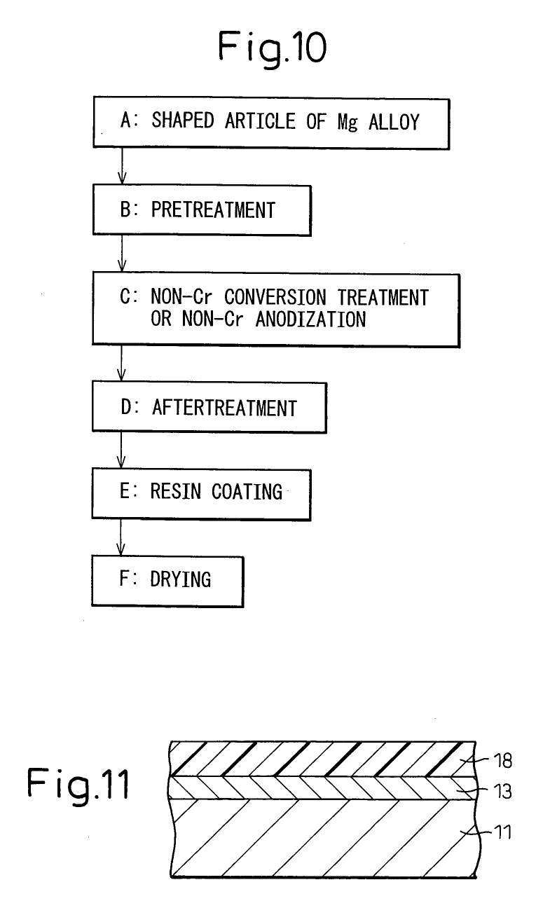

This example is intended to explain the surface treatment of the shaped metal article according to still another preferred embodiment of the present invention by referring to FIGS. 10 and 11 in which FIG. 10 is a flow-chart showing a production process of the shaped metal article and FIG. 11 is a cross-sectional view of the oxide coating-deposited shaped metal article having applied thereon an epoxy resin layer.

The procedure of Example 1 or Example 2 is repeated to produce the shaped Mg alloy article 11, followed by subjecting the article 11 to the pretreatment step B, i.e., steps B₁ to B₆, as is shown in FIG. 10. A surface of the shaped Mg alloy article 11 is thus activated and cleaned.

After completion of the pretreatment steps B₁ to B₆, the shaped Mg alloy article 11 is subjected to the non-Cr or Cr-free surface treatment C, i.e., conversion treatment C₁ described in Example 1 or anodization treatment C₂ described in Example 2. Note that, in this example for the convenience of explanation, the surface treatment is explained with reference to the conversion treatment described in Example 1.

After completion of the conversion treatment, the resulting Mg alloy article 11 having the oxide coating 13 is subjected to the after-treatment step D, i.e., steps D₁ to D₃, in accordance with the method described in Example 1. The shaped Mg alloy article 11 having on a surface thereof the non-Cr oxide coating 13 is thus obtained, as is illustrated in FIG. 11.

Thereafter, the resulting oxide coating 13 is subjected to the resin coating step E. In this resin coating step, a surface of the non-Cr oxide coating 13 of the shaped article 11 is spray coated with a coating solution of the epoxy resin, followed by drying the coating in a drying oven at, for example, about 80° C. for about 30 minutes in the drying step F. The shaped Mg alloy article 11 having on a top surface thereof an epoxy resin coating 18 having a thickness of about 5 to 15 μm is thus obtained, as is illustrated in FIG. 11.

As its surface has an epoxy resin coating 18 formed on the oxide coating 13, the shaped Mg alloy article 11 produced in this example can further improve a resistance to rust or corrosion which is basically provided by the oxide coating 13.

### Example 4

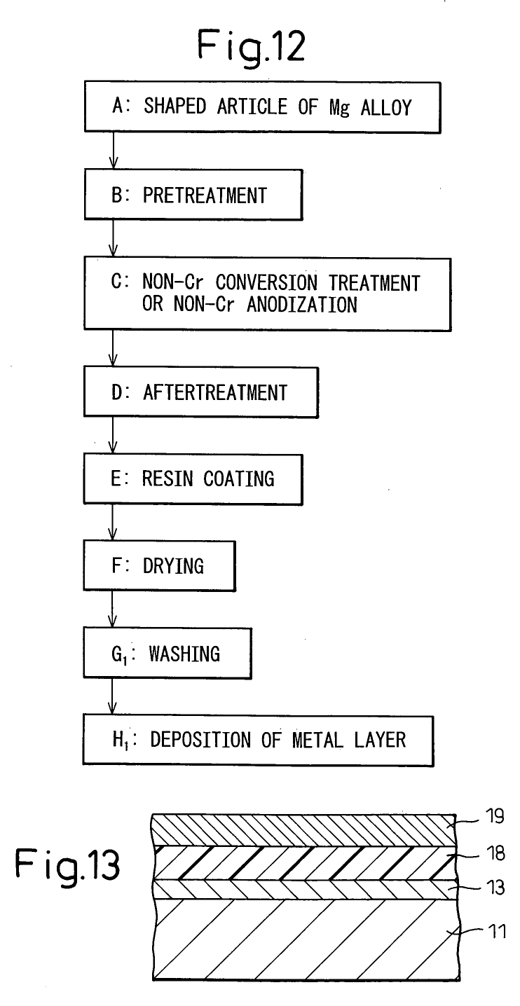

This example is intended to explain the surface treatment of the shaped metal article according to still another preferred embodiment of the present invention by referring to FIGS. 12 and 13 in which FIG. 12 is a flow-chart showing a production process of the shaped metal article and FIG. 13 is a cross-sectional view of the oxide coating-deposited shaped metal article having applied thereon, in sequence, an epoxy resin layer and an electromagnetic wave-shielding layer.

The procedure of Example 3 is repeated to produce the shaped Mg alloy article 11, followed by subjecting the article 11 to the pretreatment step B, i.e., steps B₁ to B₆, as is shown in FIG. 12. A surface of the shaped Mg alloy article 11 is thus activated and cleaned.

After completion of the pretreatment steps B₁ to B₆, the shaped Mg alloy article 11 is subjected to the non-Cr or Cr-free surface treatment C, i.e., conversion treatment C₁ described in Example 1 or anodization treatment C₂ described in Example 2. Note that, in this example for the convenience of explanation, the surface treatment is explained with reference to the conversion treatment described in Example 1.

Next, the resulting Mg alloy article 11 having the oxide coating 13 is subjected to the after-treatment step D, i.e., steps D₁ to D₃, in accordance with the method described in Example 1. The shaped Mg alloy article 11 having on a surface thereof the non-Cr oxide coating 13 is thus obtained, as is illustrated in FIG. 13.

Thereafter, the resulting oxide coating 13 is subjected to the resin coating step E and then the drying step F in accordance with the manner described in Example 3. The shaped Mg alloy article 11 having on a top surface thereof an epoxy resin coating 18 is thus obtained, as is illustrated in FIG. 13.

After formation of the epoxy resin coating 18, a surface of the Mg alloy article 11 is washed with isopropyl alcohol (IPA) in the after-treatment G₁. Then, the cleaned surface of the article 11 is vacuum deposited with aluminum (Al) at a thickness of about 1 to 5 μm on a vacuum deposition apparatus in the metal layer deposition step H₁. The shaped Mg alloy article 11 having on a top surface thereof an electromagnetic wave-shielding aluminum layer 19 is thus obtained, as is illustrated in FIG. 13.

Since its surface has a sandwich structure consisting of an oxide coating 13, an epoxy resin coating 18 and an electromagnetic wave-shielding aluminum layer 19, the shaped Mg alloy article 11 produced in this example can exhibit a better electromagnetic wave-shielding effect because of the capacitor effect originated from the sandwich structure of the coated layers.

### Example 5

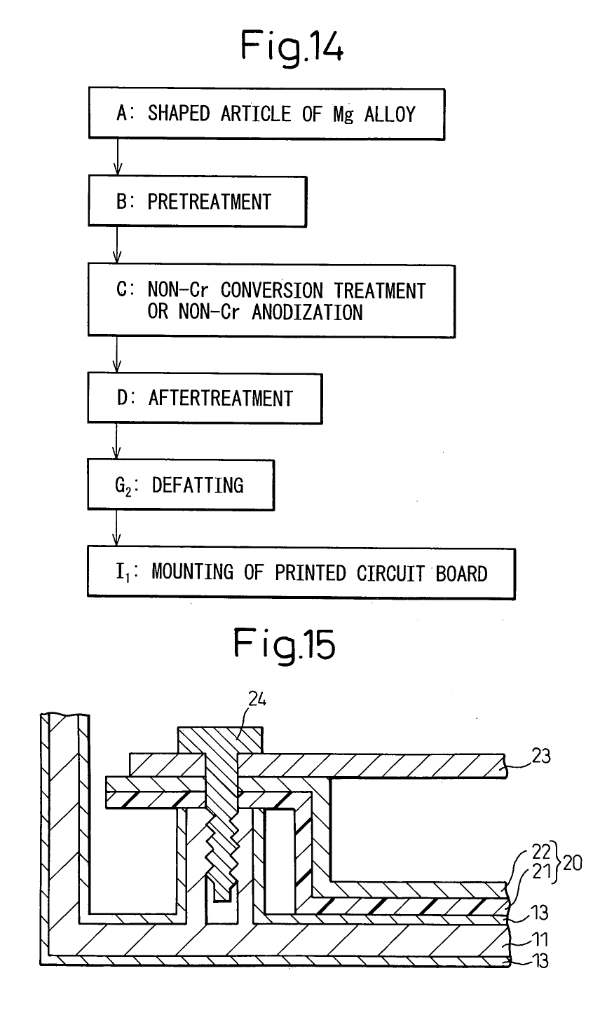

This example is intended to explain the mounting of a printed circuit board on the shaped metal article according to the present invention, referring to FIGS. 14 and 15 in which FIG. 14 is a flow-chart showing a process of mounting a printed circuit board on the shaped metal article and FIG. 15 is a cross-sectional view of the oxide coating-deposited shaped metal article having mounted thereon a printed circuit board.

The procedure of Example 1 or Example 2 is repeated to produce the shaped Mg alloy article 11, followed by subjecting the article 11 to the pretreatment step B, i.e., steps B₁ to B₆, as is shown in FIG. 14. A surface of the shaped Mg alloy article 11 is thus activated and cleaned.

After completion of the pretreatment steps B₁ to B₆, the shaped Mg alloy article 11 is subjected to the non-Cr or Cr-free surface treatment C, i.e., conversion treatment C₁ described in Example 1 or anodization treatment C₂ described in Example 2. Note that, in this example for the convenience of explanation, the surface treatment is explained with reference to the conversion treatment described in Example 1.

Next, the resulting Mg alloy article 11 having the oxide coating 13 is subjected to the after-treatment step D, i.e., steps D₁ to D₃, in accordance with the method described in Example 1. The shaped Mg alloy article 11 having on a surface thereof the non-Cr oxide coating 13 is thus obtained, as is illustrated in FIG. 15.

Thereafter, a surface of the Mg alloy article 11 is subjected to the defatting step G₂. In this defatting step G₂, a surface of the oxide coating 13 is washed and defatted with isopropyl alcohol (IPA).

After defatting, the shaped Mg alloy article 11 is subjected to the circuit board mounting step I₁. In this circuit board mounting step I₁, as is illustrated in FIG. 15, a printed circuit board 23 is mounted with a screw 24 through a conductive layer-coated resin sheet 20 on a screw-fitting section of the shaped Mg alloy article 11. The conductive layer-coated resin sheet 20 used herein comprises a resin sheet 21, made of, for example, polyimide or polyester and having a thickness of, for example, about 30 to 100 μm, and a metal coating 22 laminated or deposited on the resin sheet 21, the metal coating 22 being made of, for example, Cu or Al and having a thickness of, for example, about 0.5 to 35 μm.

According to the method of this example, as a printed circuit board 23 is screw-mounted through a resin sheet 21 with the metal coating 22 on the shaped Mg alloy article 11, it becomes possible to improve an electromagnetic wave-shielding effect for electronic parts or devices (not shown) packaged on the circuit board 23.

### Example 6

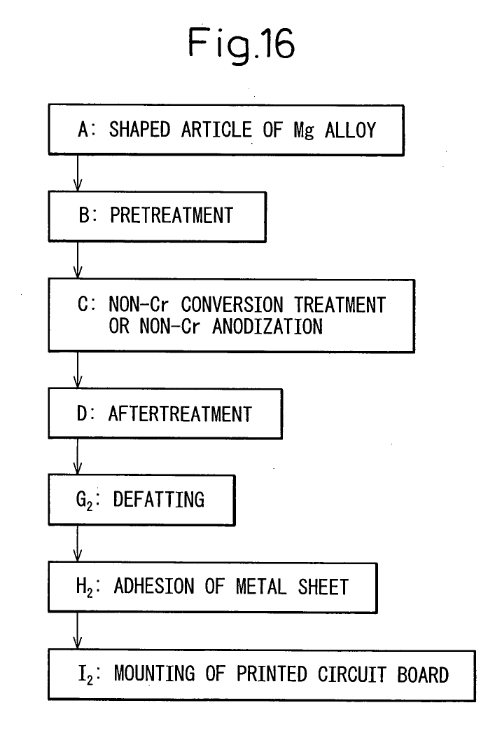

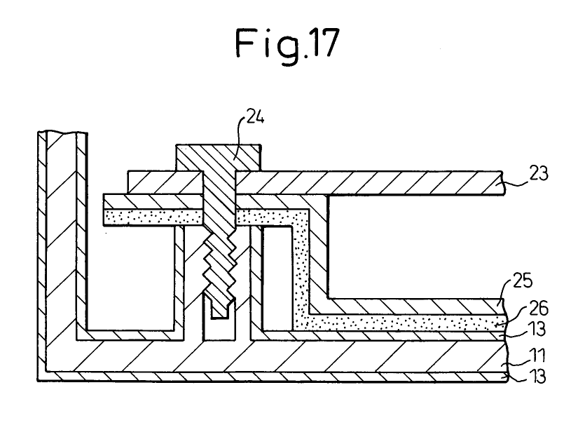

This example is intended to explain the mounting of a printed circuit board on the shaped metal article, according to the present invention, by referring to FIGS. 16 and 17 in which FIG. 16 is a flow-chart showing a process of mounting a printed circuit board on the shaped metal article and FIG. 17 is a cross-sectional view of the oxide coating-deposited shaped metal article having mounted thereon a printed circuit board.

The procedure of Example 1 or Example 2 is repeated to produce the shaped Mg alloy article 11, followed by subjecting the article 11 to the pretreatment step B, i.e., steps B₁ to B₆, as is shown in FIG. 16. A surface of the shaped Mg alloy article 11 is thus activated and cleaned.

After completion of the pretreatment steps B₁ to B₆, the shaped Mg alloy article 11 is subjected to the non-Cr or Cr-free surface treatment C, i.e., conversion treatment C₁ described in Example 1 or anodization treatment C₂ described in Example 2. Note that, in this example for the convenience of explanation, the surface treatment is explained with reference to the conversion treatment described in Example 1.

Next, the resulting Mg alloy article 11 having the oxide coating 13 is subjected to the after-treatment step D, i.e., steps D₁ to D₃, in accordance with the method described in Example 1. The shaped Mg alloy article 11 having on a surface thereof the non-Cr oxide coating 13 is thus obtained, as is illustrated in FIG. 17.

Thereafter, a surface of the Mg alloy article 11 is subjected to the defatting step G₂. In this defatting step G₂, a surface of the oxide coating 13 is washed and defatted with isopropyl alcohol (IPA).

After defatting, a metal sheet is adhered to an inner surface of the shaped Mg alloy article 11 in the metal sheet adhesion step H₂. In this metal sheet adhesion step H₂, as is illustrated in FIG. 17, a metal sheet 25, made of, for example, Cu and having a thickness of, for example, about 50 to 300 μm, is adhered through an adhesive 26 such as an epoxy-based, polyester-based or acrylic adhesive to an inner surface of the article 11.

Next, in the circuit board mounting step I₂, as is also illustrated in FIG. 17, a printed circuit board 23 is mounted with a screw 24 on a screw-fitting section of the shaped Mg alloy article 11.

According to the method of this example, as a printed circuit board 23 is screw-mounted through a metal sheet 25 on the shaped Mg alloy article 11, it becomes possible to improve an electromagnetic wave-shielding effect for electronic parts or devices (not shown) packaged on the circuit board 23, and at the same time, to improve a grounding characteristic of the circuit board 23 because of the good electrical connection condition.

### Example 7

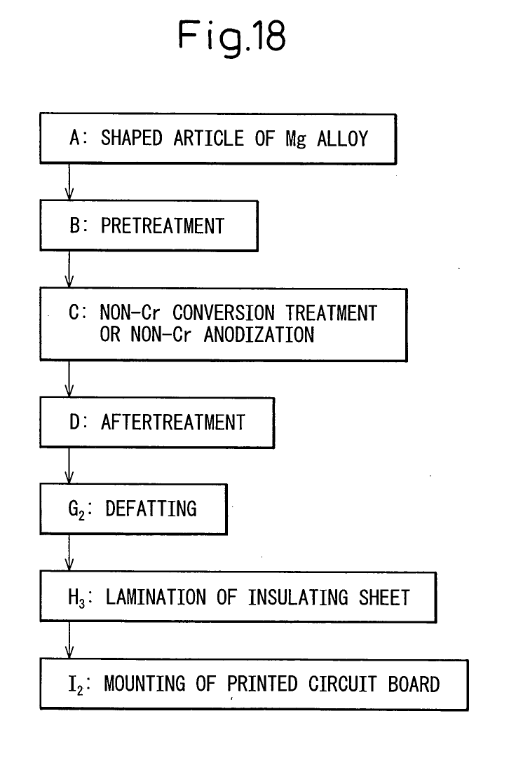

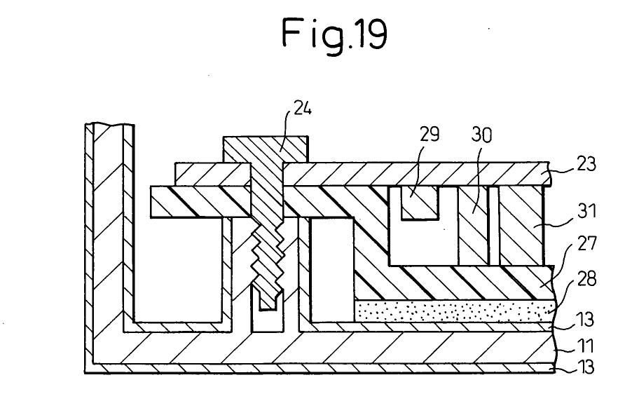

This example is intended to explain the mounting process of a printed circuit board on the shaped metal article according to the present invention, referring to FIGS. 18 and 19 in which FIG. 18 is a flow-chart showing a process of mounting a printed circuit board on the shaped metal article and FIG. 19 is a cross-sectional view of the oxide coating-deposited shaped metal article having mounted thereon a printed circuit board.

The procedure of Example 1 or Example 2 is repeated to produce the shaped Mg alloy article 11, followed by subjecting the article 11 to the pretreatment step B, i.e., steps B₁, to B₆, as is shown in FIG. 18. A surface of the shaped Mg alloy article 11 is thus activated and cleaned.

After completion of the pretreatment steps B₁ to B₆, the shaped Mg alloy article 11 is subjected to the non-Cr or Cr-free surface treatment C, i.e., conversion treatment C₁ described in Example 1 or anodization treatment C₂ described in Example 2. Note in this example that for the convenience of explanation, the surface treatment is explained with reference to the conversion treatment described in Example 1.

Next, the resulting Mg alloy article 11 having the oxide coating 13 is subjected to the after-treatment step D, i.e., steps D₁ to D₃, in accordance with the method described in Example 1. The shaped Mg alloy article 11 having on a surface thereof the non-Cr oxide coating 13 is thus obtained, as is illustrated in FIG. 19.

Thereafter, a surface of the Mg alloy article 11 is subjected to the defatting step G₂. In this defatting step G₂, a surface of the oxide coating 13 is washed and defatted with isopropyl alcohol (IPA).

After defatting, an electrical insulating sheet is adhered to an inner surface of the shaped Mg alloy article 11 in the insulating sheet lamination step H₃. In this insulating sheet lamination step H₃, as is illustrated in FIG. 19, an insulating sheet 27, made of, for example, an epoxy resin and having a thickness of, for example, about 100 to 500 μm, is adhered through a double-faced adhesive tape 28 to an inner surface of the article 11.

Next, in the circuit board mounting step I₂, as is also illustrated in FIG. 19, a printed circuit board 23 is mounted with a screw 24 on a screw-fitting section of the shaped Mg alloy article 11.

According to the method of this example, as a printed circuit board 23 is screw-mounted through a soft insulating sheet 27 on the shaped Mg alloy article 11, it becomes possible to prevent electronic parts or devices 29 to 31 packaged on the circuit board 23 from the damage due to mechanical contact or from the short-circuit due to electrical contact, thereby improving the stability of the electronic devices.

Hereinabove, some examples of the present invention were described. However, the present invention should not be restricted to the conditions, constitutions and others described in the examples, and thus the conditions and others may be widely modified or changed. For example, the present invention should not be restricted to a composition and concentration of the treating solution, a layer thickness, a temperature, a voltage, a time and other numerical values described in the examples.

Referring to the examples described above, aluminum fluoride, aluminum nitrate or aluminum hydroxide was used as an aluminum salt in each example, but the aluminum salt should not be restricted to these three aluminum salts in the practice of the present invention. For example, aluminum chloride, aluminum sulfate, aluminum carbonate and other aluminum salts may be used in the treating solution such as a conversion or anodization reaction solution.

Further, zirconium sulfate was added as a zirconium salt to the conversion or anodization reaction solution in each example, but any other zirconium salt such as zirconium chloride may be added to these reaction solutions.

Furthermore, zirconium sulfate, a surface active agent, a rust inhibitor, a pH controlling agent or an oxidizing agent was added to the conversion or anodization reaction solution in each example, but it should be noted that the addition of these additives is optional, and only the addition of the aluminum is essential in the practice of the present invention.

Furthermore, though not described in the above examples, it is of course possible to carry out the water washing step in, for example, two or more steps between the pretreatment step B and the non-Cr surface treatment step C, if desired.

Furthermore, a shaped metal article used in each example was a shaped article made of a magnesium alloy, but the metal material used in the formation of the shaped metal article is not restricted to the magnesium alloy. For example, the shaped metal article may be formed from a single metal such as magnesium, aluminum and zinc, or from a metal alloy containing zinc or aluminum as a principal component.

Moreover, the shaped metal article was produced using the die casting method in each of the examples. However, the shaping process of the metal material to form the shaped metal article may be carried out with the shaping method other than the die casting method. Typical examples of suitable shaping method include a thixotropic molding method, a sheet pressing method and a forging method.

In addition, the surface roughening treatment of the metal article was carried out with a sand blasting method in the pretreatment step B1. However, this roughening treatment is not restricted to the blasting method, and it may be replaced with, for example, a mechanical polishing method such as a hair line finishing method using metallic brushes and a buffing method, i.e., polishing using buffs.

In Example 3 and others, an epoxy resin coating was applied as a synthetic resin coating over the oxide coating of the shaped metal article. However, the resin coating to be applied over the oxide coating is not restricted to the epoxy resin coating, and it may be replaced with a coating of other synthetic resins such as an acrylic resin, acryl-urethane resin, acryl-silicone resin, acryl-epoxy resin, melamine resin, acryl-melamine resin, melamine-epoxy resin, polyester resin, polyester-epoxy resin and fluorinated ethylene-based compound. Note that the synthetic resin coating applied over the oxide coating is not restricted to a single layer, and thus it may be formed as a layer having the multilayered structure.

Moreover, the method for the formation of the synthetic resin coating is not restricted to the spray coating method. The synthetic resin layer may be formed using a conventional coating method, electrostatic spraying method, dipping method, electroplating method, powder deposition method and coating or layer formation method using an aqueous emulsion.

In Example 4, an aluminum layer was deposited on the epoxy resin coating to form an electromagnetic wave-shielding metal layer. However, the metal used in the formation of the electromagnetic wave-shielding metal layer is not restricted to aluminum, and thus the metal layer may be formed from other metals such as nickel, chromium, brass, copper, silver, gold, titanium, iron, zinc, platinum, rhodium, cobalt, tin, carbon, boron, bismuth, indium and an alloy thereof.

Moreover, the method for the formation of the metal layer is not restricted to a vacuum deposition method, and thus the metal layer may be formed using other coating or layer formation methods such as a plating method, sputtering method and ion plating method.

In Example 5, a conductive layer-coated resin sheet was used for mounting a printed circuit board on the shaped Mg alloy article. However, the present invention is not restricted to use of the conductive layer-coated resin sheet, and thus the resin sheet may be replaced with another resin film or sheet having coated thereon at least one metal layer such as a metal layer duplitized, i.e. double-side coated substrate, a metal layer-sandwiched substrate and a flexible substrate. Especially, the flexible substrate is useful, because it can be used as a wiring to the electric source or a signal wiring, in addition to exhibiting an electromagnetic wave-shielding effect.

In Example 6, a metal sheet consisting of copper (Cu) was adhered to an oxide coating of the shaped Mg alloy article. However, the present invention is not restricted to use of the Cu sheet, and thus the Cu sheet may be replaced with a sheet made of other metals such as silver, gold, aluminum, carbon, iron, stainless steel, titanium, tin, nickel and chromium. Further, the metal sheet may be replaced with a metal member having other configurations such as a metal tape.

In Example 7, an insulating sheet made of a polyester resin was used and adhered for mounting a printed circuit board on the shaped Mg alloy article. However, the present invention is not restricted to use of the insulating polyester sheet, and thus the polyester sheet may be replaced with a sheet made of other insulating materials such as nylon and polyimide. Further, the insulating sheet may be replaced with an insulating member having another configuration such as an insulating tape.

1. A shaped metal article comprising a metal body having applied on a surface thereof an oxide coating, in which
said metal body is constituted from a single metal selected from the group consisting of magnesium, aluminum and zinc, or a metal alloy containing as a principal component at least one metal selected from the group consisting of magnesium, aluminum and zinc, and
said oxide coating is an oxide coating formed upon a surface treatment of the metal body in a treating solution containing an aluminum salt as a principal component thereof.

2. A shaped metal article as defined in claim 1, in which said oxide coating is a chromium-free oxide coating.

3. A shaped metal article as defined in claim 1, in which said oxide coating has a controlled conductivity and/or appearance color.

4. A shaped metal article as defined in claim 3, in which the controlled conductivity and/or appearance color of said oxide coating originates from controlling at least one factor selected from a composition of the treating solution containing an aluminum salt and a dipping time of the metal body in the treating solution containing an aluminum salt.

5. A shaped metal article comprising a metal body having applied on a surface thereof an oxide coating, in which
said metal body is constituted from a single metal selected from the group consisting of magnesium, aluminum and zinc, or a metal alloy containing as a principal component at least one metal selected from the group consisting of magnesium, aluminum and zinc, and
said oxide coating is an oxide coating formed upon an anodization treatment of the metal body in a treating solution containing an aluminum salt as a principal component thereof.

6. A shaped metal article as defined in claim 5, in which said oxide coating is a chromium-free oxide coating.

7. A shaped metal article as defined in claim 5, in which said oxide coating has a controlled conductivity and/or appearance color.

8. A shaped metal article as defined in claim 7, in which the controlled conductivity and/or appearance color of said oxide coating originates from controlling at least one factor selected from a composition of the treating solution containing an aluminum salt, an applied voltage and an application time of the voltage.

9. A shaped metal article as defined in claim 1, in which said oxide coating further comprises at least one synthetic resin layer applied thereon.

10. A shaped metal article as defined in claim 9, in which said synthetic resin coating further comprises at least one metal layer applied thereon.

11. A shaped metal article as defined in claim 1, in which said oxide coating further comprises a sheet-like member having coated thereon at least one metal layer, the sheet-like member at least partly contacting said oxide coating and being selected from the group consisting of a resin film, a metal tape, a metal sheet, an insulating tape of synthetic resin and an insulating sheet of synthetic resin.

12. A shaped metal article as defined in claim 11, in which said resin film is a metal layer single coated substrate, a metal layer duplitized substrate, a metal layer-sandwiched substrate or a flexible substrate.

13. A shaped metal article as defined in claim 1, in which said aluminum salt is at least one member selected from the group consisting of aluminum chloride, aluminum fluoride, aluminum sulfate, aluminum nitrate, aluminum carbonate and aluminum hydroxide.

14. A shaped metal article as defined in claim 1, in which said shaped metal article is a part of an electronic device or of electrical equipment.

15. A shaped metal article as defined in claim 1, in which said shaped metal article is a cover of the information processing device.

16. A shaped metal article as defined in claim 1, in which said shaped metal article is a casing of an electronic device or of electrical equipment.

17. A method of producing a shaped metal article comprising a metal body having applied on a surface thereof an oxide coating, which comprises:
providing a metal body having the shaped profile from a single metal selected from the group consisting of magnesium, aluminum and zinc, or a metal alloy containing as a principal component at least one metal selected from the group consisting of magnesium, aluminum and zinc, and
subjecting the metal body to a surface treatment by immersing the metal body in a treating solution containing an aluminum salt as a principal component thereof, to form an oxide coating on a surface of the metal body.

18. A method as defined in claim 17, in which said oxide coating is a chromium-free oxide coating.

19. A method as defined in claim 17, in which the surface treatment is carried out under the conditions of controlling at least one factor selected from a composition of the treating solution containing an aluminum salt and a dipping time of the metal body in the treating solution containing an aluminum salt to obtain a controlled conductivity and/or appearance color in said protective oxide coating.

20. A method of producing a shaped metal article comprising a metal body having applied on a surface thereof an oxide coating, which comprises:
providing a metal body having the shaped profile from a single metal selected from the group consisting of magnesium, aluminum and zinc, or a metal alloy containing as a principal component at least one metal selected from the group consisting of magnesium, aluminum and zinc, and
subjecting the metal body to an anodization treatment by immersing the metal body in a treating solution containing an aluminum salt as a principal component thereof, to form an oxide coating on a surface of the metal body.

21. A method as defined in claim 20, in which said oxide coating is a chromium-free oxide coating.

22. A method as defined in claim 20, in which the anodization treatment is carried out under the conditions of controlling at least one factor selected from a composition of the treating solution containing an aluminum salt, an applied voltage and an application time of the voltage to obtain a controlled conductivity and/or appearance color in said protective oxide coating.

23. A method as defined in claim 17, which further comprises forming at least one synthetic resin layer on said oxide coating.

24. A method as defined in claim 23, which further comprises forming at least one metal layer on said synthetic resin coating.

25. A method as defined in claim 17, which further comprises applying a sheet-like member having coated thereon at least one metal layer onto said oxide coating in such a manner that the sheet-like member is at least partly contacted with said oxide coating and in which said sheet-like member is selected from the group consisting of a resin film, a metal tape, a metal sheet, an insulating tape of synthetic resin and an insulating sheet of synthetic resin.

26. A method as defined in claim 25, in which said resin film is a metal layer single coated substrate, a metal layer double-side coated substrate, a metal layer-sandwiched substrate or a flexible substrate.

27. A method as defined in claim 25, in which the metal tape or the metal sheet is adhered through an adhesive to said oxide coating.

28. A method as defined in claim 17, in which said aluminum salt is at least one member selected from the group consisting of aluminum chloride, aluminum fluoride, aluminum sulfate, aluminum nitrate, aluminum carbonate and aluminum hydroxide.

29. A method as defined in claim 17, which further comprises constituting a part of the electronic device or electric equipment from said shaped metal article.

30. A shaped metal article as defined in claim 5, in which said oxide coating further comprises at least one synthetic resin layer applied thereon.

31. A shaped metal article as defined in claim 5, in which said oxide coating further comprises a sheet-like member having coated thereon at least one metal layer, the sheet-like member at least partly contacting said oxide coating and being selected from the group consisting of a resin film, a metal tape, a metal sheet, an insulating tape of synthetic resin and an insulating sheet of synthetic resin.

32. A shaped metal article as defined in claim 5, in which said aluminum salt is at least one member selected from the group consisting of aluminum chloride, aluminum fluoride, aluminum sulfate, aluminum nitrate, aluminum carbonate and aluminum hydroxide.

33. A shaped metal article as defined in claim 5, in which said shaped metal article is a part of an electronic device or of electrical equipment.

34. A shaped metal article as defined in claim 5, in which said shaped metal article is a cover of the information processing device.

35. A shaped metal article as defined in claim 5, in which said shaped metal article is a casing of an electronic device or of electrical equipment.

36. A method as defined in claim 20, which further comprises forming at least one synthetic resin layer on said oxide coating.

37. A method as defined in claim 20, which further comprises applying a sheet-like member having coated thereon at least one metal layer onto said oxide coating in such a manner that the sheet-like member is at least partly contacted with said oxide coating and in which said sheet-like member is selected from the group consisting of a resin film, a metal tape, a metal sheet, an insulating tape of synthetic resin and an insulating sheet of synthetic resin.

38. A method as defined in claim 20, in which said aluminum salt is at least one member selected from the group consisting of aluminum chloride, aluminum fluoride, aluminum sulfate, aluminum nitrate, aluminum carbonate and aluminum hydroxide.

39. A method as defined in claim 20, which further comprises constituting a part of the electronic device or electric equipment from said shaped metal article.
